(19) United States
(12) Patent Application Publication
(10) Pub. No.: US 2010/0083713 A1
(43) Pub. Date: Apr. 8, 2010

(54) Padlock Device Using an Electromagnetic Switch Actuated System with Fingerprint Identification System

(76) Inventor: Yiqi Wu Woodling, Carmel, IN (US)

Correspondence Address: Yiqi Wu Woodling, 14254 Trailwind Ct., Carmel, IN, 46032, US

(21) Appl. No.: 12/574,011

(22) Filed: Oct. 6, 2009

Related U.S. Application Data
(60) Provisional application No. 61/195,438, filed on Oct. 7, 2008.

(51) Int. Cl. E05B 37/00; G06K 9/00

(52) U.S. Cl. 70/22; 382/124

(57) ABSTRACT

A keyless padlock system includes an electromagnetic switch system and a fingerprint process system. The electromagnetic switch system operates the padlock with a mechanical actuated mechanism. The system also secures the padlock against the force and vibration. The fingerprint process system provides the padlock device an easy operation as the key system. The buttons and LED's manage using both fingerprint and the combination code. A changeable battery system without losing the memory provides the padlock device a reliable and easy application.

### (2) BACKGROUND OF THE INVENTION

1. Field of the Invention

The present invention generally uses an electromagnetic switch system with a dual fingerprint and combination code identification system on to the padlock mechanism as an electrical, optical, and mechanical padlock device without a physical key. It also included to the padlock on the electromagnetic switch operated a mini actuating mechanism.

2. Description of Related Art

Using a regular electromagnetic switch on a padlock, the locking system cannot keep the locking part at a safe locking position. The present invention provides the electromagnetic switch that contains the security locking switch system to the padlock. And some of fingerprint lock system with an electronic motor lock system has a high cost, thus a minimum market. The present invention will provide the users a safe, reliable, easy to use and cost effective padlock device. With a key operated padlock system, people may have the problem of a lost key. At the keyless padlock system people may have a trouble on the fingerprint or forgetting the comb number. The dual identification system of the combination code and fingerprint will provide the more solution for the application of the padlock.

### (3) SUMMARY OF THE INVENTION

Briefly and in general terms, the present invention provides a new and improved system and method for using an electromagnetic switch system and dual fingerprint and code identification system to a padlock device.

It is a particular object of the present invention to have an improved electromagnet switch contains the security locking switch system. It is still another particular object of the present invention to provide an electromagnet switch connected with the actuated mechanical operation system to the padlock device. More particularly, in an embodiment of the present invention, padlock device is provided for using the buttons operating the dual fingerprint management and combination code access system, the LED indicates the operation and the changeable battery without loss the memory of fingerprint installed. It is a further object of the present invention to have both user and manufactory access code though the fingerprint microprocessor system to the padlock.

### (4) BRIEF DESCRIPTION OF THE DRAWINGS

FIG. 1 is an isometric solid view of padlock device of the present invention shown the front side of the buttons and LED's, shown the aside of the fingerprint sensor and sensor frame.

FIG. 2 is an isometric solid view of padlock device of the present invention shown from the back and bottom side of view which has the battery door and the screw to lock the door.

FIG. 3 is an exploded perspective view of a padlock device of the present invention, including an electromagnetic switch system, shackle, sliding block, support block, battery and battery door, fingerprint sensor, PCB and padlock device housing.

FIG. 4 is an exploded perspective view of an electromagnetic switch system of the present invention that shows the detail structure of major, minor switch and stop plate.

FIG. 5 is a sketched front view of embodiment of the shackle actuating and locking mechanism inside of padlock device of the present invention.

FIG. 6 is a sketched front view of the electromagnetic switch system of the present invention.

FIG. 7 is a flow diagram of the first installation for the user or fingerprint, and an instruction for the operation of the padlock device of the present invention.

FIG. 8 is a flow diagram of the second, up to 10 user or fingerprint, installation and instruction of the padlock device of the present invention.

### (5) DETAILED DESCRIPTION OF PREFERRED EMBODIMENTS

The present invention is directed to an improved system and method for providing a user of a traditional padlock usage, but easy and convenient. The preferred embodiments of the improved system and method are fully and detailed illustrated and described in the following paragraphs.

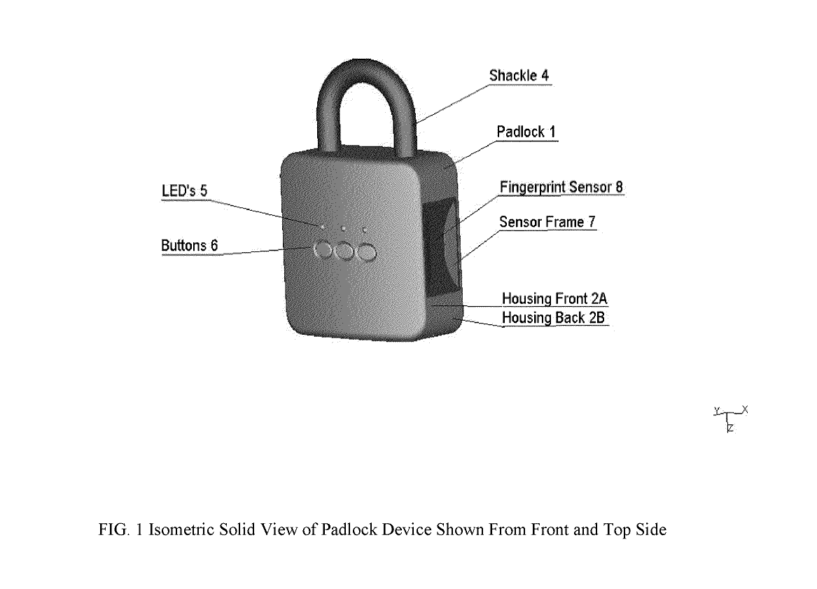

As shown in FIG. 1, the present invention relates to all types of padlocks having a shackle-type locking means held in a locking position within housing 2. The front of housing 2A has 3 buttons 6 and 3 LED's 5 to operate and indicate the padlock device for the fingerprint installation and management. The user can access the combination code though the buttons 6. The manufacture uses the buttons 6 to control and manage the padlock device with the set-up code from software. The user can install and manage the fingerprint with the buttons 6 following the LED's 5 indication.

The fingerprint sensor 8 shows at the side of the padlock device on FIG. 1. The user can use any finger to slide though the slot on the sensor frame 7 to install or open the padlock device. It gives a safe position to fingerprint sensor 8 and a convenient operation position to user.

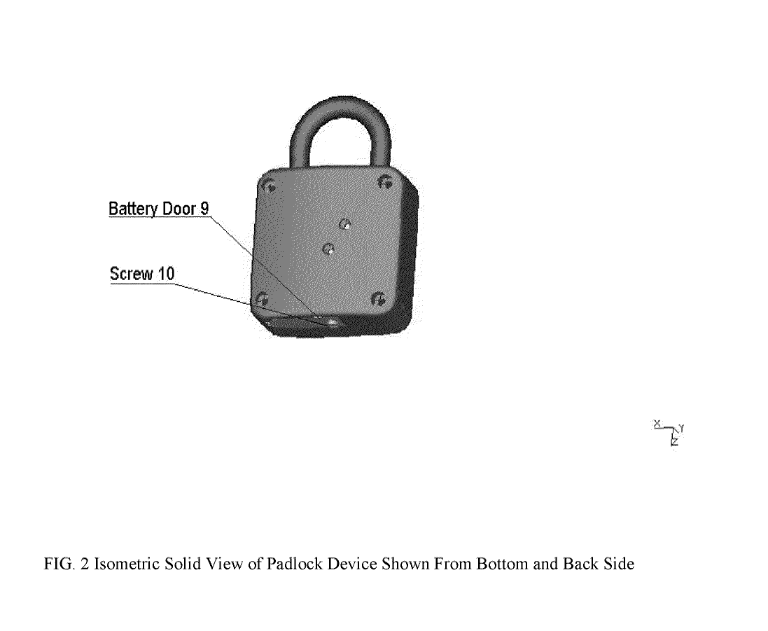

At the bottom of padlock device of present invention shown on FIG. 2, there is a battery door 9 covering the battery 18 inside of the housing 2 using a screw 10 and screwdriver. The 2 AAA batteries 18 can be exchanged without affecting the existing fingerprints function.

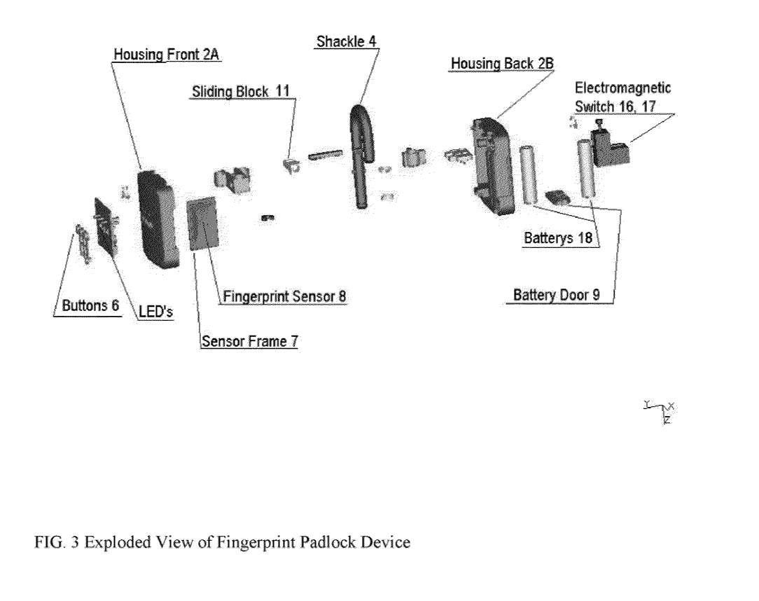

Referring to the FIG. 3, in an exploded view of the embodiment of the invention it shows the mechanical mechanism and electromagnetic switch 16, 17 at the inside of padlock device. The PCB mounted for the LED 6, button 6 switches contains microprocessor. It connects the power of the electromagnetic switch with the battery 18. It also has the connection to the optical finger sensor 8. The battery 18 and fingerprint sensor 8 are completely isolated by the housing 2 with the electromagnetic switch system and other mechanical mechanism of the padlock.

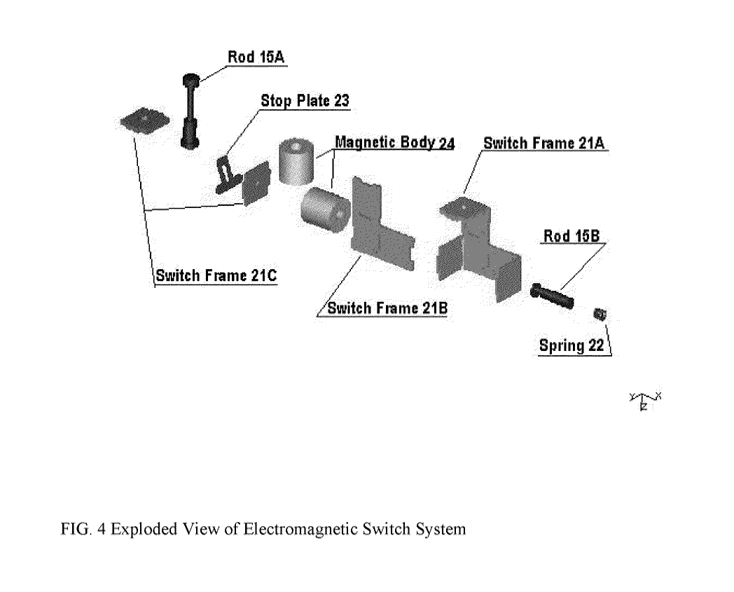

As shown in FIG. 4, there shown is the mechanism of the electromagnetic switch system of the padlock of the present invention. The rod 15A assembled to the major electromagnetic switch 16 retracted into the magnetic body 24 when the unlock signal tuned on. The magnetic body 24 holds the rod 15A until the mechanical mechanism push the rod 15A back to the locking position. The minor electromagnetic switch 17 retract to the rod 158 and pull the stop plate 23 back though the spring 22 after receive the unlock signal. It will be released after the signal off. The minor electromagnetic switch 17 has to work before the major electromagnetic switch 16 has the action. The microprocessor controls the signals in the fingerprint process system.

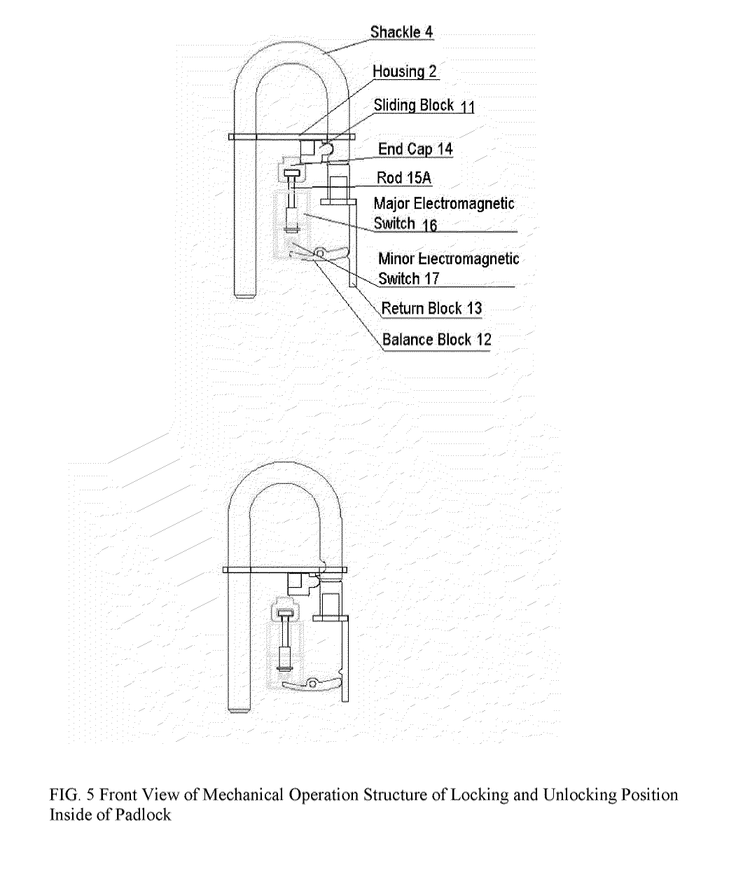

Turning to FIG. 5, there shown is an internal structure at the locking and unlocking position of the padlock of the present invention. The electromagnetic switch system 16, 17 work by on or off signal from microprocessor. When unlock signal is on, the end cap 14 follow the rod 15A slides off the sliding block 11. The sliding block 11 moves away from the shackle 4. The user can pull the shackle 4 to open the padlock.

When the user push the shackle 4 into the housing as normal padlock to lock the padlock, the return block 13 act to the balance block 12 to push the rod 15A back to the locking position. The sliding block and balance block are acted by other springs at the operation process. A sliding block 11 has the 90-degree motion with the shackle 4. When the notch on shackle 4 blocked by the sliding block 11, the padlock device will be locked. When the notch on shackle 4 has not blocked by the sliding block 11, the shackle 4 can be moved up and down. The user has to pull or push the shackle to unlock or lock the padlock device.

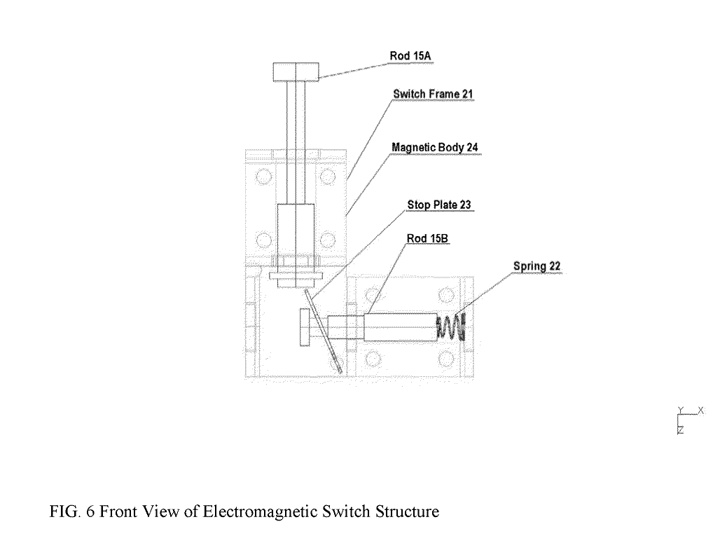

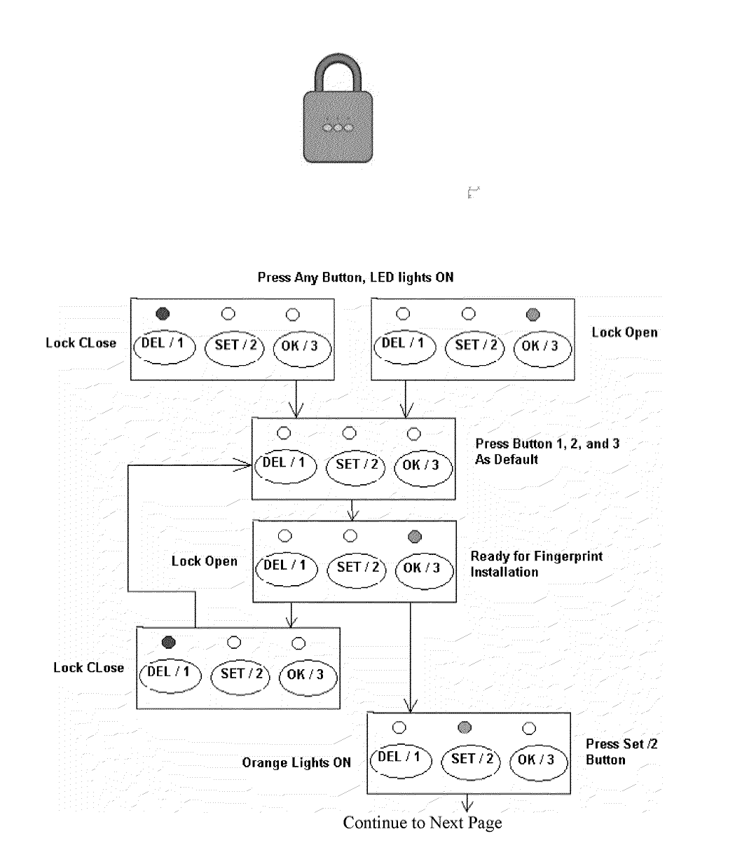

As shown on FIG. 6, the electromagnetic switch system 16, 17 contain one major switch 16, the stop plate 23 and one minor switch 17. The minor switch 17 or other type of mechanism has the function applied to the stop plate 23 and let it move on or off to the rod 15A of the major electromagnetic switch 16. The rod 15A cannot drop into the magnetic body 24 when the rod 15A holds the sliding block at the locking position of the padlock. In other words the padlock of the present invention remains in the locking position securely with any force or vibration.

On the present invention, the padlock device is operated by fingerprint. The user's finger touches the optical sensor 8; the LED light will be on and shows the lock status. The red light means the padlock locking; the green light means the padlock un-locking. If there is not operation at the device for &certain time, the LED will be off for power saving. If the battery 18 drains at the lower or dead situation, the LED will not be on at any color. This means that the user has to change the battery 18 to continue using. The existing fingerprint will be in effect after installation of the new battery.

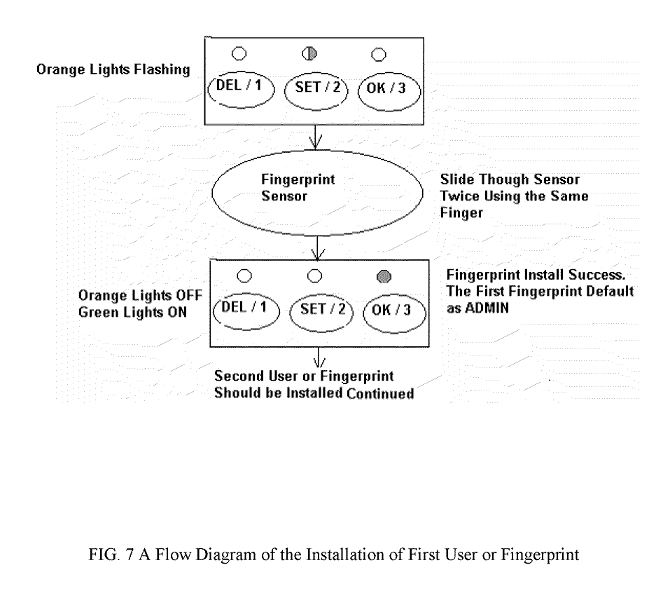

As shown in the flow diagram and instruction of first installation on FIG. 7, pressing with the manufacture default number 1, 2, and 3 on the buttons 6 of the keypad, the padlock device will be kept at the opening position. It can repeat the same opening and closing operation before the first fingerprint installed. The first user or fingerprint installation has to be at the opening position. Pressing the SET/2 button, the orange lights on and flashing after 2 sec. The user can slide the finger twice though the sensor 8 at the side of the padlock device. The orange light will be off if the sensor 8 reads confirmed. The green light will be on when the device is ready for the next installation or have the installation successful. The first user or fingerprint will be an ADMIN as default. It can manage the padlock device to set and delete the fingerprint.

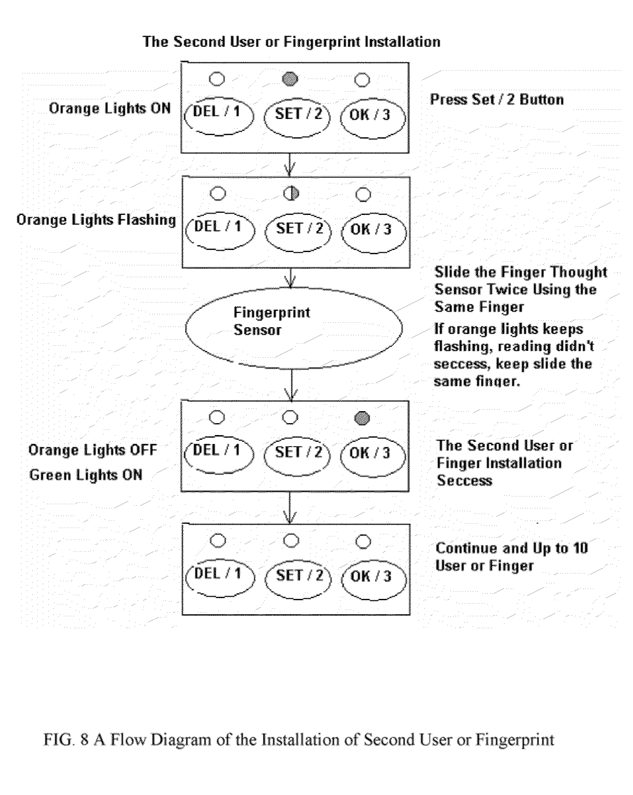

On the FIG. 8, it shows the flow diagram and instruction of second installation. The second installation has to be following the first installation from FIG. 7. Pressing the SET/2 button, the second user or fingerprint slides the finger twice though the sensor 8 after the orange lights on and flashing. The fingerprint has installed successfully after the green lights on. The fingerprint can be installed up to 10 times.

The additional new installation has to be following the process on which the ADMIN fingerprint read first and the green lights on. Pressing the SET/2 button the orange lights on and flashing. The additional new user or finger slides though the sensor 8 twice until the green lights on, installation is achieved.

It is the same process as new installation if the user or fingerprint likes to delete the existing fingerprint. The ADMIN fingerprint has to be read first and make sure the green lights on. Pressing the DEL/3 button, the orange lights on and flashing. Slide the ADMIN finger twice though the sensor again. All fingerprints of ADMIN and users are deleted. It has to press 1, 2, and 3 buttons 6 to start installation from the beginning as the flow diagram of the installation of the first user or fingerprint, show on FIG. 7.

To lock the device, the user has to close or press down the shackle. The padlock device should be locked. The LED light will change to RED.

Although the present invention has been described with the reference to particular preferred embodiments, it is to be understood that the embodiments are merely illustrative of the principles and application of the present invention. It is to be understood that numerous modifications may be made to the preferred embodiments and that other arrangements may be devised without departing from the spirit and scope of the present invention as defined by the claims.

What is claimed is:

1. A electromagnetic switch system with a fingerprint or combination code-operated padlock, comprising: a electromagnetic switch system connected with a fingerprint process system and operated a mechanical actuating mechanism mounted inside of a housing of a padlock; said fingerprint process system include a fingerprint sensor mounted on said housing and a microprocessor operation system and buttons and LED's and changeable battery mounted inside of said housing; said mechanical actuating mechanism included a sliding block, a shackle, a return block and a balance block mounted inside of said housing of a padlock and controlled by said electromagnetic switch system.

2. The system of claim 1, wherein said electromagnetic switch system includes a rod retracted though an electromagnetic switch, one main electromagnetic switch, a stop plate connected to a minor electromagnetic switch or actuating element.

3. The system as claimed in claim 2, wherein said rod of said major electromagnetic switch which only move forward, but not reversed at the locking position of a padlock.

4. The system as claimed in claim 2, wherein said stop plate which place against to said rod of said major electromagnetic switch at the lock position of a padlock.

5. The system as claimed in claim 2, wherein said rod of said minor electromagnetic switch which float with said spring and operate to said stop plate.

6. The system of claim 1, wherein said buttons managed said fingerprint process system from the surface of said housing of a padlock.

7. The system as claimed in claim 6, wherein said buttons input said digit numbers for an access code or combination code to said fingerprint processed and said electromagnetic switch operated padlock device.

8. The system as claimed in claim I, wherein said microprocessor operation system processed fingerprint image or biometric condition and digit number of said combination code.

9. The system as claimed in claim 1, wherein said LED's acted with said fingerprint process system and indicated the operation of a padlock device.

10. The system as claimed in claim 1, wherein said changeable battery supplied the power resource to a padlock device without losing the memory from said fingerprint process system.

11. The system of claim 1, wherein said changeable battery isolated from said electromagnetic switch and other elements inside of padlock by the partition of said housing.

12. The system of claim 1, wherein said mechanical actuating mechanism operated by said electromagnetic switch system and said shackle.

13. The system of claim 1, wherein said return block acted by said shackle and reacted by another force element.

14. The system of claim 1, wherein said balance block acted by said return block at the middle stop point and reacted to said rod of said major electromagnetic switch.

15. The system of claim 1, wherein said sliding block acted to said shackle as the locking or unlocking position of a padlock.
